(19) United States
(12) Patent Application Publication
(10) Pub. No.: US 2026/0322798 A1
(43) Pub. Date: Oct. 15, 2026

(54) MANAGING DYNAMIC ACCESS CONTROL AND SINGLE LOG-OUT FOR CURRENT AND FUTURE SESSIONS IN FEDERATED IDENTITY MANAGEMENT SYSTEMS

(71) Applicant: THALES DIS FRANCE SAS, MEUDON (FR)

(72) Inventors: HongQian Karen LU, Austin, TX (US); Asad Mahboob ALI, Austin, TX (US); Michael HUTCHINSON, Cedar Park, TX (US)

(73) Assignee: THALES DIS FRANCE SAS, MEUDON (FR)

(21) Appl. No.: 19/104,251

(22) PCT Filed: Aug. 10, 2023
(86) PCT No.: PCT/EP2023/072258

§ 371 Date: Feb. 17, 2025

(30) Foreign Application Priority Data
Aug. 19, 2022 (US) 17/891151

(51) Int. Cl. H04L 9/40

(52) U.S. Cl. CPC H04L 63/0815

(57) ABSTRACT

Dynamically adjustment of access control in response to one or more events observed by one of the plurality of nodes. The dynamic adjustment of access control by storing, by a first node, e.g., an identity provider or service provider, dynamic access control rules defining actions the first node takes in response to event messages received from at least one other node of said plurality of nodes; receiving, by the first node, an event message from the at least one other node of said plurality of nodes; upon receiving, by the first node, the event message, determining whether the described event triggers a rule of said stored dynamic access control rules; and upon determining that the described event triggers a rule of said stored dynamic access control rules, executing the action indicated by said triggered rule.

### BACKGROUND OF THE INVENTION

The present invention relates, generally, to authentication and access management in federated identity management protocols, and, more particularly, to use of shared signals for dynamic access control and single log-out in conjunction with federated identity management systems.

Federated Identity Management protocols provide mechanisms by which access to webservices on multiple service providers is simplified for users by allowing authentication to an Identity Provider (IdP) and to use of that authentication for authentication to other service providers that have been configured for authentication by the identity provider. Thus, Federated Identity Management alleviates the challenges associated with managing user credentials for multiple service providers.

Ancillary to Federated Identity Management, federated login, also known as Single-Sign On (SSO), uses an Identity Provider to allow users to authenticate once to obtain access to multiple service providers. For example, on a first user accesses of one of several service providers that are registered with the same IdP, the user would authenticate to the IdP and gain access to that service provider. On a login attempt to a second service provider, the user may access that second service provider based on the identity that was established when logging in to the first service provider.

Log in attempts at a service provider is redirected to the IdP and the IdP manages the login process according to access control policies of the various service providers. Access control policies are defined using an IdP's access management system, which typically enable service provider administrators to setup access control policies that specify which users or group of users are allowed access to specific applications of the service provider, with what conditions, and the authentication mechanisms that are required. Such access control policy management is manual and static. The access control policies do not dynamically adapt to changing context, nor do the access control policies update automatically to reflect changing context.

Single LogOut (SLO) is the converse operation to SSO. Whereas SSO allows a user to sign-in once for access to multiple service providers, SLO provides a mechanism by which when a user logs out from, or is automatically logged out from, one service provider of several service providers to which the user has been logged in using SSO through an IdP, SLO logs the user out from the other service providers that share the SSO session from the IdP. As users may not affirmatively log out from all service provider sessions, it is desirable that when a user logs out from one SSO session, that the user is logged out from any other active service provider sessions as any pending active session may leave the user's accounts on such service providers vulnerable to attack.

SLO is not reliable. The SLO process is inherently sequential due to web browser's HTTP redirect and is not universally implemented. The foreground SLO process operates as a sequence of logout requests and logout responses. If one service provider fails to respond with an expected logout response message, the sequence may be broken and SLO may not occur on any service providers who are down-stream in the sequence of HTTP redirects. The background SLO process is rarely implemented by both IdP and service providers.

The SSO, SLO, and access control policies are typically configured statically beforehand. SPs do not know if some of their shared users become malicious or their accounts are compromised and have little opportunity to adjust the configurations or their actions. This can cause both security and usability problems.

From the foregoing it is apparent that there is a need for an improved method for dynamically adapting access control to changing contexts and for improving the reliability of single logout processes.

### SUMMARY

The herein presented technology provides an improved mechanism for dynamically adapting access control to changing contexts and for improving the reliability of single logout processes. In an aspect, the presented technology is an improved method and, in another aspect, a server-having a processor, a communications interface connected to a network, and a non-volatile storage facility connected to the processor and for storing data and programs implementing the improved method.

A first node, which may be an identity provider server, in an identity management system supporting single-sign on to a plurality of nodes, to dynamically adjust access control in response to one or more events observed by one of the plurality of nodes, dynamically adjust access control by storing dynamic access control rules defining actions the first node takes in response to event messages received from at least one other node of said plurality of nodes. The first node receives an event message from the at least one other node of said plurality of nodes and upon receiving, by the first node, the event message, determines whether the described event triggers a rule of said stored dynamic access control rules. Upon determining that the described event triggers a rule of said stored dynamic access control rules, the first node executes the action indicated by said triggered rule.

The first node may further store access control policies, wherein the dynamic access control rules modify implementation of the access control policies based on said triggering activities.

The identity management system may be a federated identity management system.

The event described in the event message may be an activity performed by a user.

The user may be a registered user of a subset of the plurality of nodes.

The first node may be an identity provider. Furthermore, the first node may be a subscriber node in a publisher-subscriber scheme.

The action of the triggered rule may be to transmit a take-action message to one or more nodes of said plurality of nodes.

The event message may be received from a second node, and wherein the action applies to a scenario selected from the group of scenarios including:
adjusting implementation of access control solely for the second node and solely for the user referred to in the event message for a current sign-on session
adjusting implementation of access control for a plurality of nodes and solely for the user referred to in the event message for a current sign-on session
adjusting implementation of access control solely for the second node and for a plurality of users associated with the event message for a current sign-on session
adjusting implementation of access control for a plurality of nodes and for a plurality of users associated with in the event message for a current sign-on session
adjusting implementation of an access control solely for the second node and solely for the user referred to in the event message for a future sign-on session
adjusting implementation of an access control for a plurality of nodes and solely for the user referred to in the event message for a future sign-on session
adjusting implementation of an access control solely for the second node and for a plurality of users associated with the event message for a future sign-on session
adjusting implementation of an access control for a plurality of nodes and for a user other than the user referred to in the event message for a future sign-on session.

The triggering action may be a federated single-log out message performed by the first user and the corresponding action is transmission by the identity provider of an event message to a plurality of nodes having active single-sign-on sessions with the first user in order to log out the first user from the plurality of nodes.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of a model for asynchronous communication among service providers in a publisher-subscriber framework wherein each service provider may publish events directly to any another service provider.

FIG. 2a is a database-table template illustrating fields of a database table of access control policies stored by a first node, e.g., the identity provider of FIG. 1.

FIG. 2b is an example of a database table of access control policies according to the database-table template of FIG. 2a.

FIG. 3a is a database-table template illustrating fields of a database table of dynamic access control rules for dynamic adjustment of access control stored by a node, e.g., the identity provider or a service provider node of the publisher-subscriber network of FIG. 1.

FIG. 3b is an example of a database table of dynamic access control rules according to the database-table template of FIG. 3a.

FIG. 4 is a hardware architecture of an identity provider server or another node of the publisher-subscriber network of FIG. 1.

FIG. 5 is a layout diagram for non-volatile storage of the server of FIG. 4.

FIG. 6 is a flow-chart illustrating the process by which, a node, e.g., an identity provider or a service provider node, receives event messages, determines if a dynamic access control rule action is triggered by an event, and taking appropriate action if such is the case.

FIG. 7 is a timing sequence diagram illustrating an example message flow for a subscriber node taking an action in response to an event message from a publisher node in a publisher-subscriber framework and application of dynamic access control rules to take actions in response thereto.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The following description includes references to various methods executed by a processor of an integrated circuit chip. As is common in the field, there may be phrases herein that indicate these methods or method steps are performed by software instructions or software modules. As a person skilled in the art knows, such descriptions should be taken to mean that a processor, in fact, executes the methods, software instructions, and software modules.

The herein described technology provides a mechanism for enhancing access control management and Single Log-Out (SLO) processing in Federated Identity Management systems. The herein-described technologies address the above-discussed issues by using shared signals among an Identity Provider (IdP) and multiple service providers (SPs) in a Federated Identity Management system. The herein-described technologies rely on a publisher-subscriber mechanism, such as CAEP, to provide for asynchronous communication among the IdP and SPs. Such asynchronous communication is used to dynamically manage access control, inform about actions to take, and to ensure that SLO operates reliably.

Dynamic adjustments to access control are applicable to both active sessions and future working sessions. Furthermore, adjustments made due to events at one service provider may apply to both that service provider and to other service providers that obtain federated identity at same or different SPs. The adjustments can be based on subscribers'risk tolerance and the nature of the triggering event, instead of static access control policies predefined by administrators or dictated by protocol limitations.

The herein-described technology allows for adjustment to access control policies to adapt the access control to changing situations. For example, when a first service provider sends a notification of an event that a user behaved maliciously and was forced to logout, the IdP may decide to strengthen the access control for those SPs that have signed up for the dynamic controls. This method is applicable to not only SPs that the user has logged in to, but also to those SPs that the user may login in the future.

A publisher-subscriber model is a mechanism in which networked nodes may asynchronously transmit messages to other nodes and thereby provide shared signals among these nodes. A sender, known as a publisher, sets up a topic or creates an event and publishes the messages related to the topics to other nodes, known as subscribers, who subscribe to messages from the publisher or to messages related to a topic. In other words, when a publisher publishes a message regarding a topic or event, nodes that subscribe to the topic or event receive the published messages. Messages may have some filtering parameter associated with them, e.g., a topic, or may be restricted to certain sets of subscribers, e.g., members of a particular organization or function.

The Continuous Access Evaluation Profile (CAEP) framework from the OpenID Foundation is an example publisher-subscriber framework. CAEP is described in Tulshibagwale, A. et al., OpenID Shared Signals and Events Framework Specification 1.0—draft 01, The OpenID Foundation, 2021, accessed on Jan. 15, 2022, incorporated in its entirety herein by reference.

Typically, rather than sending messages to specific nodes, a publisher makes messages available without knowledge of which subscribers will have access to the messages and, conversely, a subscriber subscribes to messages that belong to a topic of interest to the subscriber.

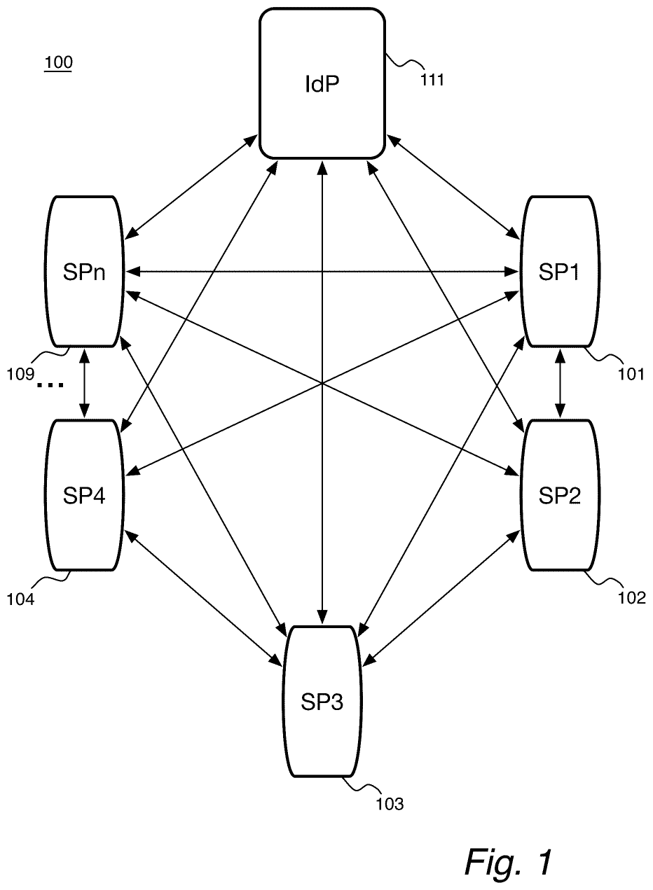

FIG. 1 is an illustration of a model 100 for asynchronous communication among a network of service providers SP1 101 through SPn 109 that use a common federated identity provider (IdP) 111. With Single Sign-On (SSO), for a user to log in to anyone of the service providers SP1 101 through SPn 109, the user logs into an account at the federated identity provider (IdP) 111. If the user has logged into SP1 101 via a successful authentication at the IdP 111, when the user wants to login to another service provider, e.g. SP2 102, the user does not need to authenticate again because of SSO, unless the access control policy of the other service provider (e.g., SP2 102) requires to authenticate for every session.

Each of the service providers, SP1 101 through SPn 109, may publish informational messages, e.g., event messages, to other service providers 101 through 109 as well as to the identity provider 111. These event messages may provide some information pertaining to a particular user or a group of users. The event messages may indicate, for example, that the user is suspected of being an impostor, that the user is misbehaving in some fashion (accessing unauthorized files, deleting files, editing files without authorization, etc.), or that the user's activity is noteworthy for some other reason.

Access control policies define the requirements by which a user, or a group of users, access a particular service. Examples of access control policies include:
Must authenticate each session
May authenticate using federated log on
May authenticate with username and password
Must authenticate with multi-factor authentication using username/password and biometric
Must authenticate with multi-factor authentication using username/password, biometric and authentication device, e.g., a smart card
Must reauthenticate according to a time-period, e.g., daily, weekly
Must reauthenticate when in a new location

### Table 1: Examples of Access Control Policies

As Table 1 illustrates, there is no particular limit on access control policies and specific policies are outside the scope of this disclosure.

Dynamic access control rules are mechanisms to allow access control to be dynamically adjusted due to a change in circumstance. A change in circumstance may be, for example, that a user operating under a particular access control policy is deemed to have engaged in a suspicious activity that may be indicative that the user's login credentials may have been breached, that the user has turned into a malicious user attempting access to services to which they are not entitled to access, or an innocent action such as moving from one location to another.

According to the technology described herein, access controls are dynamically adjusted based on dynamic access control rules (DACRs) that may be triggered by specific events. These events are communicated by the various service provider nodes, e.g., SP1 101 through SPn 109 of FIG. 1, to a first node, e.g., the identity provider 111 of FIG. 1. Herein, the first node will be referred to as the identity provider 111. However, any node in the network can perform the functionality described herein as being performed by the identity provider 111.

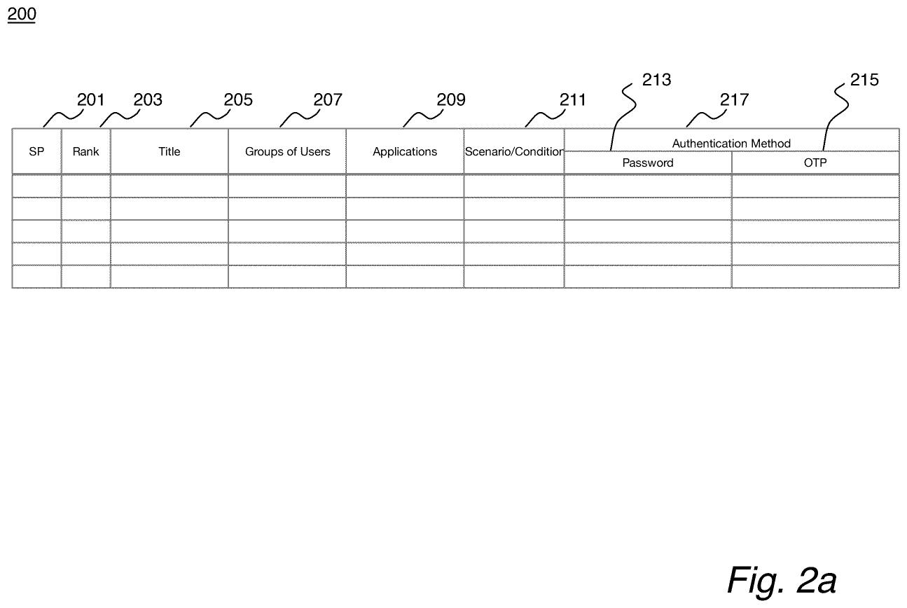

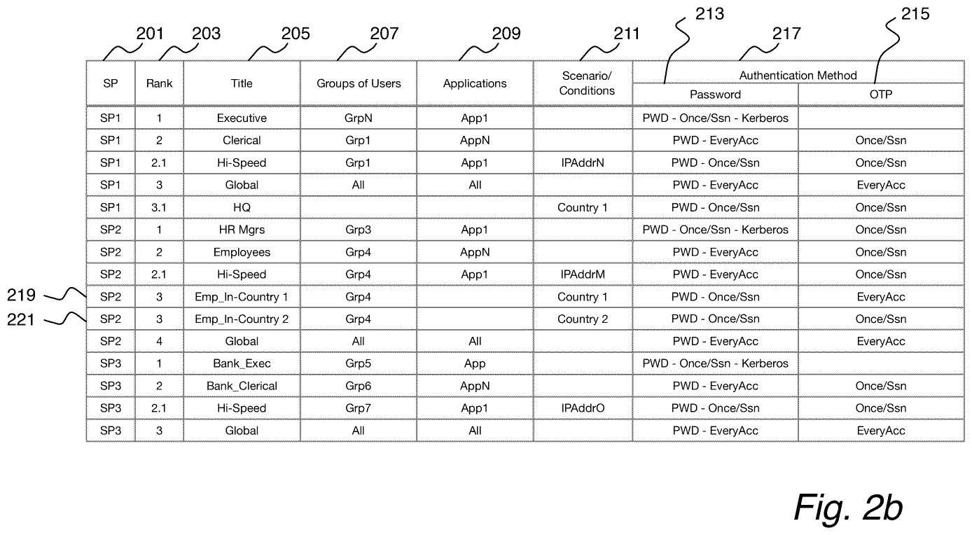

FIG. 2a is an example database-table template 200 illustrating fields of a database table of access control policies stored by a first node, e.g., the identity provider 111 of FIG. 1. Each row in an access control policies table defines one access control policy. The columns of the table template 200 for access control policies include (the columns may be viewed as fields of an access control policy):
An SP column 201 that specifies which service provider the access control policy pertains to.
A rank column 203 that may be used by a dynamic access control rule to, for example, dynamically move a user of a service provider from a less restrictive access control policy (lower rank) to a more restrictive access control policy (higher rank).
A title column 205 that provides a name for an access control policy.
A groups of users column 207 that defines users to which an access control policy pertains.

Groups may, for example, be defined by different corporate departments, different roles, and different privilege classes. Note that a group can be a single user.
An applications column 209 that defines particular applications of a service provider that the access control policy pertains to.
A scenarios/conditions column 211 that defines scenarios or conditions that are a condition for the application of the access control policy.
Two columns 213 and 215 that combined are referred to as the authentication method 217.

The password column 213 defines the requirements for entering a password and the OTP (one-time password) column defines the requirements pertaining to one-time passwords.

### Table 2: Access Control Policy Template Columns

FIG. 2b is an example 200′ of a database table of access control policies according to the database-table template of FIG. 2a.

It may be noted that each record in the table pertains to a particular service provider and to a particular group of users or to all users and defines the access control policy for those users when using services of that service provider. The access control policy may be specific to a particular application.

Consider records 219 and 221. Both of these records pertain to SP2 and the group of users referred to as Grp4. However, record 219 applies when a user from Grp4 is in Country 1 and record 221 applies when a user from Grp4 is in Country 2. In the former case, OTP is used for every access to the service provider, whereas for the latter case, OTP is used once per session.

According to the herein described technology, circumstances can occur that causes the identity provider 111 to take certain actions depending on event messages. Such actions may include moving a user from one access control policy to another, requiring that the user be logged out from current sessions, requiring re-authentication, etc.

Events that may trigger such an action include detection of possible user malfeasance, detection of possible compromised user credentials, an attack against a service provider.

According to the herein described technology, rules referred to herein as Dynamic Access Control Rules (DACRs) specify events and actions to be taken in response to such events. The events may be sent by any node, e.g., a service provider node 101 through 109, using a publisher subscriber system as a message, referred to herein as an event message and received by the identity provider node 111. The identity provider node then refers to a table of dynamic access control rules to determine if a rule applies and then takes a specified action.

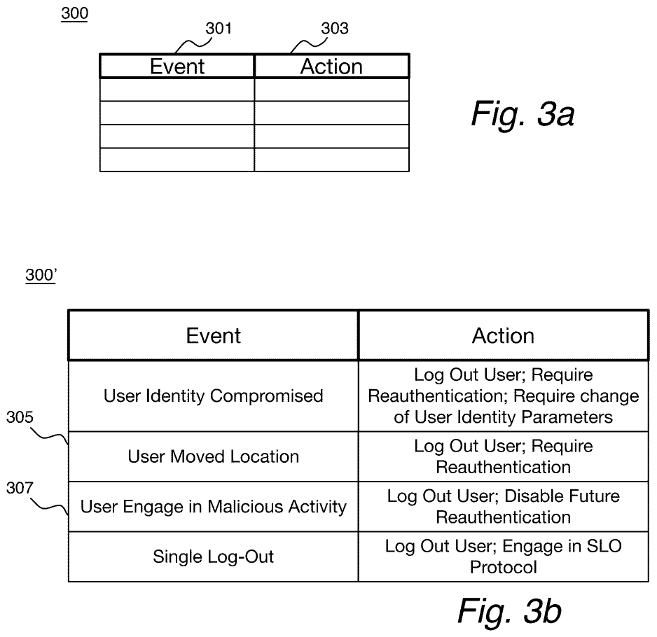

FIG. 3a is an example database-table template 300 illustrating fields of a database table of dynamic access control rules for dynamic adjustment of access control by a first node, e.g., the identity provider 111 of FIG. 1. Each row in a dynamic access control rules table defines one dynamic access control rule. The columns of the table template 300 for dynamic access control rules (the columns may viewed as fields of a dynamic access control rule) include a column 301 defining a triggering event and a column 303 defining actions to be taken in response to the event being triggered.

FIG. 3b is an example 300′ of a database table of dynamic access control rules according to the database-table template 300 of FIG. 3a. Consider, for example, row 305. According to that rule, if an event message is received by the identity provider 111 indicative of that a user has moved location, the identity provider 111 seeks to affect a logout of the user and requiring the user to re-authenticate. Conversely, according to rule 307, if the user has engaged in some malicious activity, the identity provider 111 seeks to affect logout of the user and disables all future reauthentication of the user.

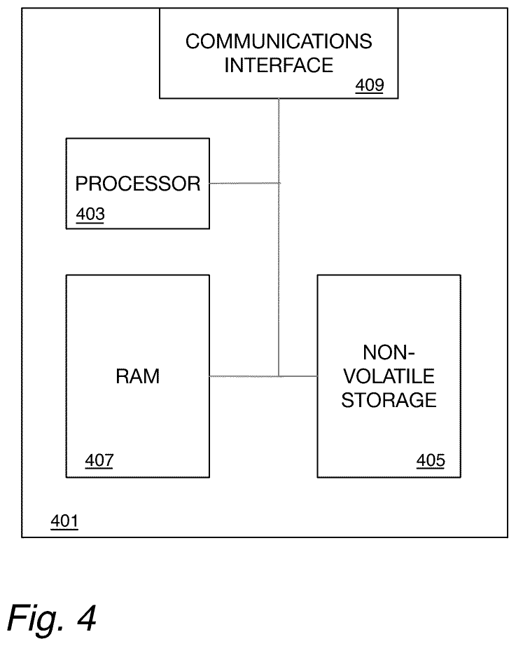

FIG. 4 is a hardware architecture diagram of an identity provider server 401 corresponding to the identity provider node 111 of FIG. 1. The identity provider server 401 contains one or more processors 403, a non-volatile storage 405 for storing programs and data, a random-access memory 407 for temporary storage of program data, and a communications interface 409 for connecting to other servers and nodes. The various service-provider servers 101 through 109 may have similar structures.

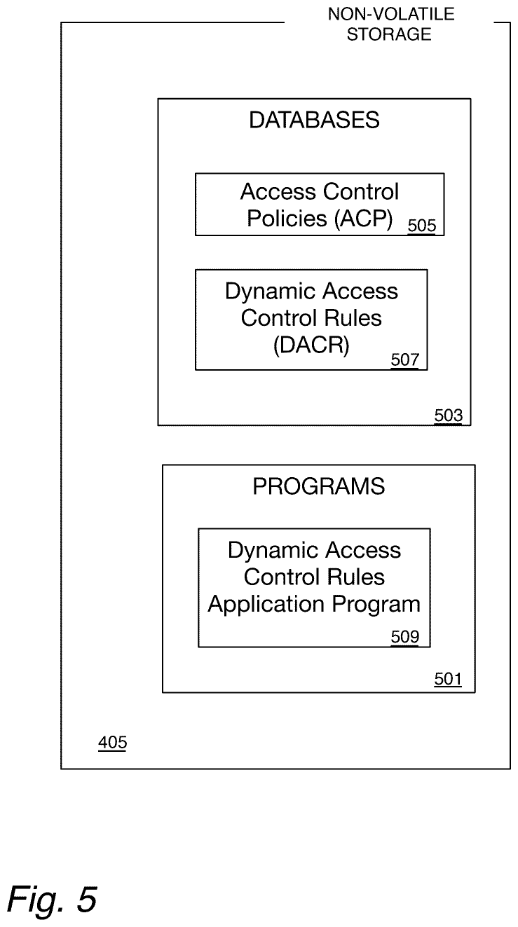

FIG. 5 provides a high-level diagram illustrating storage layout in the non-volatile storage 405. The non-volatile storage 405 may contain programs 501, including a dynamic access control application program 509 for directing the processor(s) 503 to perform the mechanisms to protect provide dynamic access control according to the methods described herein. The non-volatile storage 405 may also contain databases 503, including tables 505 and 507 that are tables according to templates 200 and 300 containing access control policies and dynamic access control rules, like tables 200′ and 300′, respectively.

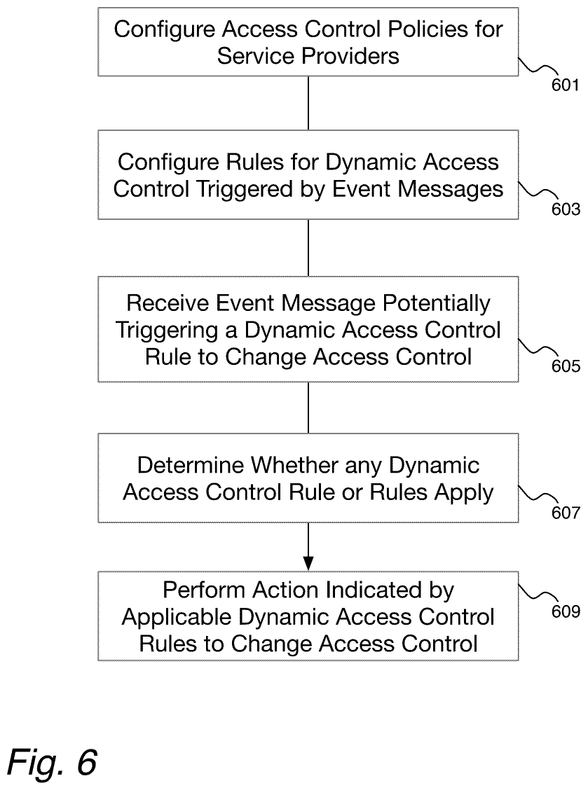

FIG. 6 is a flow-chart illustrating the process by which, a first node, e.g., an identity provider, receives event messages, determines if a dynamic access control rule to take an action is triggered by an event described in an event message, and taking appropriate action if such is the case.

Step 601, which may be considered a preliminary or setup step: Administrators of service providers configure access control policies for access to services at their respective service provider nodes. Access control policies may, for example, be set up using SafeNet Trusted Access from the SafeNet subsidiary of Thales S.A., the assignee of this patent application.

Step 603: Configure dynamic access control rules triggered by event messages. As discussed hereinabove, dynamic access control rules define actions, i.e. changes in access control to be performed when a certain event occurs. The events are described in event messages received via messages transmitted on a publisher-subscriber framework. As discussed in conjunction with FIG. 3, the dynamic access control rules may be configured as table entries having a triggering event and an action to be taken in response to such a triggering event.

Step 605: Receive one or more event messages that potentially trigger a dynamic access control rule to change access control with respect to one or more users of one or more service providers.

Step 607: Determine whether any dynamic access control rule or rules apply. The identity provider node 111 server searches the dynamic access control rule table 300 to determine whether any rule matches the described event in a received event message. Depending on implementation, the rule matching may be performed, for example, using string matching or enumeration of values indicative of a potentially rule-triggering event, e.g., 1=“User Compromised”, 2=“User Moved”, etc.

Step 609: Perform actions indicated by applicable dynamic access control rules to change access control for users that the event message pertains to. Examples of such actions include logging out the user, requiring re-authentication, changing authentication requirements, and barring the user from future authentication.

The actions taken may include:
adjusting implementation of access control solely for the publisher node and solely for the user referred to in the event message for a current sign-on session
adjusting implementation of access control for a plurality of nodes and solely for the user referred to in the event message for a current sign-on session
adjusting implementation of access control solely for the publisher node and for a plurality of users associated with the event message for a current sign-on session
adjusting implementation of access control for a plurality of nodes and for a plurality of users associated with in the event message for a current sign-on session
adjusting implementation of an access control solely for the publisher node and solely for the user referred to in the event message for a future sign-on session
adjusting implementation of an access control for a plurality of nodes and solely for the user referred to in the event message for a future sign-on session
adjusting implementation of an access control solely for the publisher node and for a plurality of users associated with the event message for a future sign-on session
adjusting implementation of an access control for a plurality of nodes and for a user other than the user referred to in the event message for a future sign-on session.

### Table 3: Actions in Response to Triggering Events

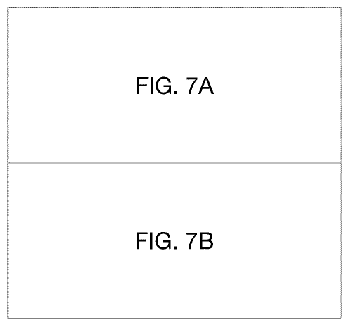

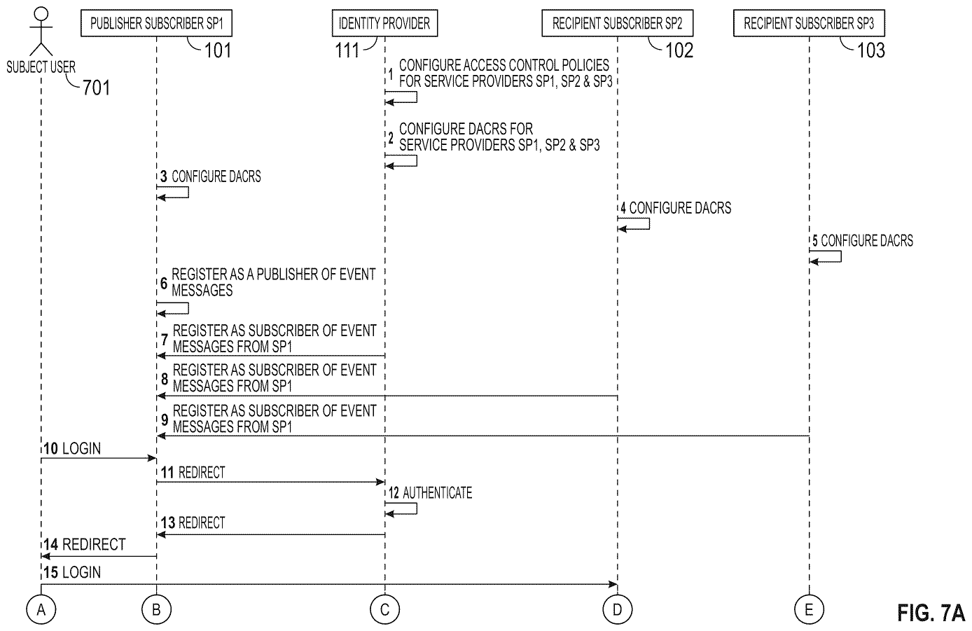

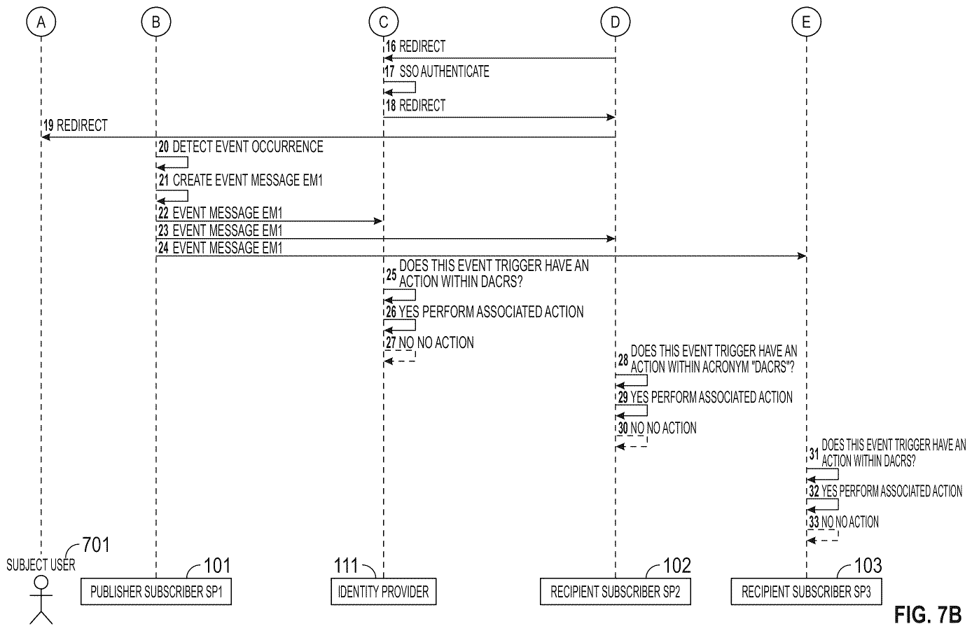

FIG. 7 is a timing sequence diagram illustrating an exemplary message flow to affect dynamic access control.

Step 1: The identity provider (IdP) 111 configures access control policies for service providers for whom the IdP 111 provides identity services, e.g., SP1 101, SP2 102, and SP3 103.

Step 2: The IdP 111 configures dynamic access control rules (DACRs) for the service providers for whom the IdP 111 provides identity services, e.g., SP1 101, SP2 102, and SP3 103.

Steps 3,4, and 5: The various service providers, e.g., SP1 101, SP2 102, and SP3 103, also configure DACRs. Thus, a service provider may have a dynamic access control rule that defines the actions that a service provider takes in response to a certain event; i.e., corresponding to the first bullet of Table 3. For example, a service provider may have as a policy that if user moves to a new location, regardless of the access control policies of the IdP, the service provider requires re-authentication of that user.

Step 6: The mechanism of notifying events that may be cause for change of access control is communication via a publisher-subscriber network. Thus, any service provider that intends to publish such messages registers on the publisher-subscriber network as a publisher of event messages. While FIG. 7 illustrates SP1 101 as an event publisher, any node can register to publish events.

Steps 7, 8, and 9: Conversely, any node that wishes to receive event messages from a publisher registers with that publisher as a subscriber of events. In this example, the IdP 111 and service providers SP2 102 and SP3 103 registers with SP1 101 to receive event messages from SP1 101.

Steps 10, 11, 12, 13, 14: A subject user 701 logs into SP1 101. Because SP1 uses the IdP 111 for federated authentication services, the login is redirected (step 11) to the IdP. The IdP authenticates the user (step 12) and the result is redirected back to SP1 101 (step 13), and SP1, in turn, redirects the login result to the user (step 14).

Steps 15, 16, 17, 18, 19: The subject user 701 logs into SP2 102, which also is performed using federated login via the IdP 111. This time, because of the previous authentication in step 12, the IdP 111 authenticates the user through single-sign on (SSO) (step 17).

Step 20: the publisher node SP1 101 detects an event occurrence that merits reporting to the subscriber nodes. Such an event occurrence could be an innocent action by the subject user of SP1 101, such as moving from one location to another, or the event occurrence could be a suspicious activity on the part of the subject user 701 of SP1 101. Service providers, such as SP1 101, typically monitor user behavior. Thus, if a user starts accessing resources that they usually do not access or do not have a right or need to access, the service provider may flag that activity as suspicious and report the activity to subscriber nodes.

Step 21: if the publisher service provider SP1 101 determines that the occurrence merits publication, the publisher service provider SP 101 creates an event message EM1 for publication.

Steps 22, 23, and 24: the publisher, service provider SP 101, publishes the event message EM1 to the subscriber nodes, i.e., the IdP 111 and the subscriber service providers SP2 102 and SP3 103.

Steps 25, 26, and 27: the IdP 111 determines whether the event triggers an action within the dynamic access control rules that the IdP stores (step 25). If the event triggers an associated action, the IdP performs such specified action (step 26), e.g., informing other SPs to logout the subject user, requiring re-authentication for subsequent log in attempts, altering the authentication requirements. Conversely, if no DACR is triggered, no action is taken (step 27).

Steps 28-33: Similarly, as the individual service providers also may store DACRs, they may perform a determination of whether any of their respective DACRs are triggered (steps 28 and 31); if triggered, the service providers take actions specified by the DACR (steps 29 and 32); and, conversely, if no DACRs are triggered, the service providers take no action (steps 30 and 33).

### Single Log-Out (SLO)

Federated identity management protocols, such as SAML (Security Assertion Markup Language—OASIS Security Services (SAML) TC, OASIS Open, https://www.oasis-open.org/committees/tc_home.php?wg_abbrev=security, accessed on, Jun. 28, 2022) and OpenID Connect (Welcome to OpenID Connect, OpenID Foundation, https://openid.net/connect/, accessed on, Jun. 28, 2022), allow for Single Sign-On (SSO) and Single Log-Out (SLO). If configured with SSO, once a user has logged into one Service Provider (SP) through the Identity Provider (IdP), they can log into other SP's, which have been configured with the same IdP, without needing to authenticate again unless the policy requires it. With SLO, when a user logs out from one SP, they can be logged out from all the other SPs that share the same Single Sign-On session from the IdP. However, the SLO is not always reliable. This is because the foreground SLO process is inherently sequential due to web browser's HTTP redirect. If one of the SPs fails to respond, the process stops.

An action that may be triggered by a DACR is to perform a Single Log-Out (SLO) procedure. A triggering event may be that the subject user initiates a Log-Out at a IdP indicating that all sessions started through the IdP should be terminated. Similarly, a log-out at one service provider may be an indication to log out all other sessions.

The following procedure allows SAML or OIDC federated events to be treated as publisher/subscriber (pub/sub) events. For example, an IdP or an SP can send a federated single logout message. This event message starts a sequence of SLO in which the original federated message to initiate a SLO process is translated into a pub/sub event message. The IdP can simultaneously send the logout request to other interested SAML or OIDC parties.

Assume a user has logged into SP1 101 via the IdP 111 and has used the SSO session to access SP2 102 and SP3 103. Also assume that all the service providers have registered for SLO.

The subject user 701 logs out of the SSO session from the IdP 111, which triggers an SLO event message transmitted to all the subscriber SPs. The IdP 111 ends SSO session to prevent future SSO sessions. The IdP 111 identifies a list of existing SP sessions associated with the existing SSO session, which includes sessions with SP1, SP2, and SP3.

The IdP 111 starts SLO, via browser redirect (front channel), to one SP after another until the list is complete. If one failed, however, e.g., the browser redirect ends on an SP's error page, the process is stopped.

To address the potential of SLO failure, the IdP 111 executes the following process.

In a first embodiment, the IdP 111 navigates a subset of the SAML or OIDC redirects required due to SSO authentications and determines SPs missing from that set, that is SPs that never received the SLO directive. In response, the IdP 111 generates a Publisher/subscriber based logout request for each of the SPs missing from the set. That is, the IdP could reach some of the SPs in the SSO session but not the other SPs in the same session. In this case, the IdP sends a pub/sub logout message (e.g., a CAEP message) for these remaining SPs in the SSO session to logout.

In a second embodiment, the IdP 111 ignores the SAML or OIDC redirects required due to SSO authentications and instead generates only a pub/sub (e.g., CAEP) message logout request for each of the SPs. That is, the IdP 111 does not use SAML or OIDC SLO mechanisms. Rather, the IdP 111 sends pub/sub (e.g., CAEP) messaging to send logout messages to each of the SPs.

The logout all request is sent from the browser session with an SP to the IdP 111. The IdP 111 sends pub/sub messages (e.g., CAEP messages) to all the subscriber SPs in parallel. The IdP 111 may send back status to the original browser session from time to time. Eventually the IdP 111 sends a success or failure message to the original browser session; success of the SLO could be partial with respect to the SPs involved in the SSO session that is to be terminated.

If the subject user selects the logout-all from an SP, which supports SLO, the SP informs the IdP 111. The IdP 111 starts the logout-all process as described above.

From the foregoing it will be apparent that the herein described techniques provide an efficient and secure mechanism for dynamically updating access control and triggering a robust single logout process in federated single sign-on sessions. The described techniques use publisher/subscriber messages to message other publisher/subscriber nodes, including identity provider and service provider nodes to take required action such as updating access control and to logout users logged in through single sign-on sessions.

Although specific embodiments of the invention have been described and illustrated, the invention is not to be limited to the specific forms or arrangements of parts so described and illustrated. The invention is limited only by the claims.

We claim:

1. A method for operating a first node, in an identity management system supporting single-sign on to a plurality of nodes, to dynamically adjust access control in response to one or more events observed by one of the plurality of nodes, the method comprising:
storing, by the first node, dynamic access control rules defining actions the first node takes in response to event messages received from at least one other node of said plurality of nodes;
receiving, by the first node, an event message from the at least one other node of said plurality of nodes;
upon receiving, by the first node, the event message, determining whether the described event triggers a rule of said stored dynamic access control rules; and
upon determining that the described event triggers a rule of said stored dynamic access control rules, executing the action indicated by said triggered rule.

2. The method of claim 1, further comprising:
storing, by the first node, access control policies, wherein the dynamic access control rules modify implementation of the access control policies based on said triggering activities.

3. The method of claim 1, wherein the identity management system is a federated identity management system.

4. The method of claim 1, wherein the event described in the event message is an activity performed by a user.

5. The method of claim 4, wherein the user is a registered user of a subset of the plurality of nodes.

6. The method of claim 1, wherein the first node is an identity provider.

7. The method of claim 1, wherein the first node is a subscriber node in a publisher-subscriber scheme.

8. The method of claim 1, wherein said action of said triggered rule is to transmit a take-action message to one or more nodes of said plurality of nodes.

9. The method of claim 4, wherein the event message is received from a second node, and wherein the action applies to a scenario selected from the group of scenarios including:
adjusting implementation of access control solely for the second node and solely for the user referred to in the event message for a current sign-on session
adjusting implementation of access control for a plurality of nodes and solely for the user referred to in the event message for a current sign-on session
adjusting implementation of access control solely for the second node and for a plurality of users associated with the event message for a current sign-on session
adjusting implementation of access control for a plurality of nodes and for a plurality of users associated with in the event message for a current sign-on session
adjusting implementation of an access control solely for the second node and solely for the user referred to in the event message for a future sign-on session
adjusting implementation of an access control for a plurality of nodes and solely for the user referred to in the event message for a future sign-on session
adjusting implementation of an access control solely for the second node and for a plurality of users associated with the event message for a future sign-on session
adjusting implementation of an access control for a plurality of nodes and for a user other than the user referred to in the event message for a future sign-on session.

10. The method of claim 4, wherein the triggering action is a federated single-log out message performed by the first user and the corresponding action is transmission by the identity provider of an event message to a plurality of nodes having active single-sign-on sessions with the first user in order to log out the first user from the plurality of nodes.

11. A server, operated as a first node in a federated identity management system operable to allowing federated single-sign on to a plurality of nodes, for dynamically adjusting access control in response to events observed by one of the plurality of nodes, the server comprising:
a processor,
a communications interface connected to the processor and to a network, and
a non-volatile storage facility connected to the processor for storing data and programs, the non-volatile storage facility comprising:
access control policies for users and user groups;
dynamic access control rules defining actions the identity provider takes in response to event messages received from at least one node; and
program instructions that direct the processor to:
store, by the identity provider server, dynamic access control rules defining actions the identity provider server takes in response to event messages received from at least one other node of said plurality of nodes;
receive, by the identity provider server, an event message from the at least one other node of said plurality of nodes;
determine, upon receiving, by the identity provider server, whether the event message triggers a rule of said stored dynamic access control rules; and
execute, upon determining that the described event triggers a rule of said stored dynamic access control rules, the action indicated by said triggered rule.

12. The server of claim 11, wherein the instructions that direct the process further comprises instructions to cause the processor to:
store, by the identity provider server, access control policies, wherein the dynamic access control rules modify implementation of the access control policies based on said triggering activities.

13. The server of claim 11, wherein the identity management system is a federated identity management system.

14. The server of claim 11, wherein the event described in the event message is an activity performed by a user.

15. The server of claim 14, wherein the user is a registered user of a subset of the plurality of nodes.

16. The server of claim 11, wherein said action of said triggered rule is to transmit a take-action message to one or more nodes of said plurality of nodes.

17. The server of claim 14, wherein the event message is received from a second node, and wherein the action applies to a scenario selected from the group of scenarios including:
adjusting implementation of access control solely for the second node and solely for the user referred to in the event message for a current sign-on session
adjusting implementation of access control for a plurality of nodes and solely for the user referred to in the event message for a current sign-on session
adjusting implementation of access control solely for the second node and for a plurality of users associated with the event message for a current sign-on session
adjusting implementation of access control for a plurality of nodes and for a plurality of users associated with in the event message for a current sign-on session
adjusting implementation of an access control solely for the second node and solely for the user referred to in the event message for a future sign-on session
adjusting implementation of an access control for a plurality of nodes and solely for the user referred to in the event message for a future sign-on session
adjusting implementation of an access control solely for the second node and for a plurality of users associated with the event message for a future sign-on session
adjusting implementation of an access control for a plurality of nodes and for a user other than the user referred to in the event message for a future sign-on session.

18. The server of claim 14, wherein the triggering action is a federated single-log out message performed by the first user and the corresponding action is transmission by the identity provider of an event message to a plurality of nodes having active single-sign-on sessions with the first user in order to log out the first user from the plurality of nodes.

19. The server of claim 11 wherein the server is an identity provider server operated by an identity provider.

20. The server of claim 11 wherein the server is a service provider server operated by a service provider.
